(19) United States
(12) Patent Application Publication
(10) Pub. No.: US 2025/0011180 A1
(43) Pub. Date: Jan. 9, 2025

(54) SULFIDE CERAMIC ELECTROLYTES

(71) Applicants: SAFT, LEVALLOIS PERRET (FR); Centre national de la recherche scientifique, PARIS (FR); ECOLE NATIONALE SUPERIEURE D INGENIEURS DE CAEN, CAEN CEDEX 4 (FR); UNIVERSITE DE CAEN NORMANDIE, CAEN (FR)

(72) Inventors: Vincent PELE, BORDEAUX (FR); Christian JORDY, PAREMPUYRE (FR); Audric NEVEU, CAEN (FR); Valérie PRALONG, CAEN (FR)

(73) Assignees: SAFT, LEVALLOIS PERRET (FR); Centre national de la recherche scientifique, PARIS (FR); ECOLE NATIONALE SUPERIEURE D INGENIEURS DE CAEN, CAEN CEDEX 4 (FR); UNIVERSITE DE CAEN NORMANDIE, CAEN (FR)

(21) Appl. No.: 18/711,237

(22) PCT Filed: Nov. 17, 2022
(86) PCT No.: PCT/EP2022/082298

§ 371 Date: May 17, 2024

(30) Foreign Application Priority Data
Nov. 18, 2021 (FR) FR2112210

(51) Int. Cl. C01D 15/00; H01M 4/04; H01M 10/0525; H01M 10/0562

(52) U.S. Cl. CPC C01D 15/00; H01M 4/0471; H01M 10/0525; H01M 10/0562; C01P 2002/72; C01P 2002/90; H01M 2300/0068

(57) ABSTRACT

The present invention relates to sulfide solid electrolytes having improved conductivity, a process for the preparation thereof, and electrochemical elements and batteries containing same.

### CROSS REFERENCE TO RELATED APPLICATION

The present application is a U.S. National Phase Application under 35 U.S.C. § 371 of International Patent Application No. PCT/EP2022/082298 filed Nov. 17, 2022, which claims priority of French Patent Application No. 21 12210 filed Nov. 18, 2021. The entire contents of which are hereby incorporated by reference.

### FIELD OF THE INVENTION

The present invention relates to the field of batteries and in particular to batteries having a solid electrolyte of sulfide type.

### BACKGROUND

Sulfide solid electrolytes have reached a sufficient stage of development to envisage the industrial use thereof. With their high ionic conductivity associated with ductility and limited mass density, they emerge as serious candidates for the first generations of all-solid-state batteries able to compete with the energy densities of current Li-ion secondary batteries having liquid electrolytes.

Recent progress in the field of sulfide electrolytes particularly concerns the discovery of novel chemical compositions and novel crystallographic structures allowing improvements in performance, in particular in terms of chemical and electrochemical stability, ductility, conductivity, etc. . . . .

US 2016/0149258 concerns sulfide solid electrolytes and notably describes electrolytes of formula Li_{5x+2y+3}P₁₋ₓS₄ and Li₅ₓ₊₃P₁₋ₓS₄, i.e. depleted of phosphorus.

To improve conductivity, it is generally sought to increase the Li/P ratio. However these lithium-rich materials are more costly.

Novel compounds have now been discovered based on sulfur, lithium, and phosphorus, that are supplemented with phosphorus. These compounds correspond to phases which have not yet been described.

Therefore, a first subject of the present invention concerns a compound of formula (I):

$${( {Li}_{3} {P}_{1 + x} {S}_{4} )}_{1 - y} {( Li X )}_{y} \qquad ( I )$$

where:
0<x<0.2;
0≤y≤0.3;
Each X, the same or different for each group LiX, represents a halogen atom chosen from among Cl, I, Br, F.

In particular, measurements of conductivity have shown that this compositional domain allows conductivity to be improved compared to that of the Li₃PS₄ compound, particularly when compounds of formula (I) and Li₃PS₄ are synthesized under the same conditions.

### SUMMARY

The following embodiments can be cited, each of the embodiments able to be considered alone or in any possible combination thereof:

In one embodiment, these phases particularly involve the existence of a uniqueness within the compositional domain Li₂S—P₍₂₊ₓ₎S₅.

More particularly, analysis of structure by XRD conducted on this compositional domain is marked by the onset of diffraction peaks which do not correspond to the precursors P₂S₅ and Li₂S, or to the known reference compounds Li₃PS₄ or Li₄P₂S₆.

In one embodiment, in formula (I) y=0.

In one embodiment, x is between 0.04 and 0.14.

In one embodiment, the compounds of formula (I) are chosen from among Li₃P_{1.04}S₄, Li₃P_{1.09}S₄, and mixtures thereof, in particular the compound Li₃P_{1.09}S₄.

In one embodiment, the compounds of formula (I) are in crystalline or partially crystalline form.

In particular, the compounds of formula (I) display an X-ray diffraction peak (XRD) at 2θ=19.1°+/−0.25 obtained with the copper K(alpha) line.

Also, in one embodiment, the ratio between the maximum intensity of the diffraction pattern in the range Iₘₐₓ [17°;18.5°] relative to the maximum intensity of the pattern in the range Iₘₐₓ [18.5°;19.5°] is higher than 0.1, preferably between 0.1 and 1.00.

In addition, in one embodiment, the ratio of signal intensity at I=34.00° relative to the maximum intensity of the diffraction pattern in the range Iₘₐₓ [29.5°;31°] is higher than 0.04, preferably between 0.04 and 1.00.

The values of the intensities correspond to the difference between the value of the pattern signal and the value of the signal corresponding to the background noise of the pattern.

A further subject of the invention concerns the process for preparing a compound such as defined above, said process comprising:
the step of mixing powders of the precursors P₂S₅ and Li₂S,
the addition of phosphorus at zero oxidation state, then
processing the mixture thus obtained.

The precursors P₂S₅ and Li₂S are commercially available, for example these materials can be obtained from Aldrich or Alfa Aesar.

Typically, the precursors are in crystalline form. In one embodiment, processing can be performed by mechanical grinding or heating in particular.

In one embodiment, heating is conducted at a temperature lower than 300° C., typically at a temperature of between 175 and 225° C.

In one embodiment, co-grinding can be carried out by mixing said precursors in the desired proportions, typically in the proportions heeding the molar ratios required by formula (I).

In one embodiment, co-grinding can be conducted at ambient temperature.

In one embodiment, co-grinding can be performed by ball milling. Typically, co-grinding can be performed using a ball mill marketed by (Fritsch 7), with balls having a diameter of between 0.1 and 15 mm, in 10 to 50 ml bowls, for cycles lasting between 1 mn and 2 hours over a total time of between 5 and 100 h, at a rotation speed of between 100 and 1000 rpm. Typically, the particle size of the mixture after co-grinding is less than 20 μm, in particular less than 5 μm.

In one embodiment, the precursors P₂S₅ and Li₂S are mixed in contents such that the respective molar ratio n(P₂S₅)/n(Li₂S) is between 2.5 and 2.98%.

Typically, phosphorus is added in an amount such that the molar ratio n(phosphorus at oxidation state 0)/(nP₂S₅+nLi₂S) is between 0.01 and 0.10.

A further subject of the invention concerns a sulfide solid electrolyte for battery comprising a compound of formula (I) of the invention.

More particularly, said sulfide solid electrolyte has a conductivity value of the lithium ions at ambient temperature higher than that of Li₃PS₄, in particular when said compound of formula (I) and Li₃PS₄ are synthesized under the same conditions.

In one embodiment, said electrolyte is suitable for batteries of «all-solid-state» type.

A further subject of the invention concerns an electrochemical element comprising an electrolyte of the invention. More particularly, said electrochemical element is an all-solid-state element comprising a cathode layer, an anode layer and an electrolyte layer between the anode and cathode layers, such that said electrolyte layer contains the sulfide solid electrolyte of the invention.

The electrochemical element of the invention is particularly suitable for lithium secondary batteries such as Li-ion secondary batteries, primary Li (non-rechargeable) and Li—S batteries, and the equivalents thereof with other alkaline elements (Na-ion, K-ion, . . . ) with the corresponding formulations.

The invention also concerns a module comprising a stack of at least two electrochemical elements of the invention, each element being electrically connected to one or more other elements.

The term «module» herein therefore designates the assembly of several electrochemical elements.

A further subject of the present invention concerns a battery comprising one or more modules of the invention.

By «battery» or «secondary battery», it is meant the assembly of several modules, said assemblies possibly being in series and/or parallel. The invention preferably concerns secondary batteries having a capacity higher than 100 mAh, typically of 1 to 100 Ah.

### BRIEF DESCRIPTION OF THE DRAWINGS

FIG. 1 gives the ternary diagram of sulfur, lithium and phosphorus (A), and the X-ray diffraction pattern of compositions in the binary domain Li₂S—P₍₂₊ₓ₎S₅ (B).

FIG. 2 gives conductivity and activation energy measurements in the binary domain Li₂S—P₍₂₊ₓ₎S₅.

FIG. 3 illustrates stability in a symmetric cell for electrolytes of the invention (x=0.04/0.09/0.14) in comparison with Li₃PS₄.

FIG. 4 gives the cycling curves in an all-solid-state battery, in NCA cell (LiₓNi_{0.8}Co_{0.15}Al_{0.05}O₂)/graphite for electrolytes of the invention (x=0.04 (A), x=0.09 (B), x=0.14 (C) in comparison with Li₃PS₄; and (D) the polarization for electrolytes of the invention (x=0.04/0.09/0.14) in comparison with Li₃PS₄

### DETAILED DESCRIPTION

The following examples are representative, nonlimiting examples of one embodiment of the invention.

At a first stage, the precursors are weighed, mixed and ground in a mortar (total of 2.5 g) in the following proportions:

| | | Li₂S | | P₂S₅ | | P° | |
|---|---|---|---|---|---|---|---|
| Counter- | Li₃PS₄ | 0.95691 | g | 1.54308 | g | 0 | g |
| example | | | | | | | |
| Example 1 | Li₃P_{1.04}S₄ | 0.95010 | g | 1.53210 | g | 0.01778 | g |
| Example 2 | Li₃P_{1.09}S₄ | 0.94280 | g | 1.52034 | g | 0.03684 | g |
| Example 3 | LI₃P_{1.14}S₄ | 0.93498 | g | 1.50772 | g | 0.05729 | g |
| Example 4 | Li₃P_{1.19}S₄ | 0.92655 | g | 1.49413 | g | 0.07930 | g |

The mixture of precursors is placed in a 20 mL zirconium grinding bowl containing 4 balls of diameter 10 mm, and these bowls are placed in a planetary ball mill (Fritsch Pulverisette 7). The grinding conditions are as follows: 500 rpm, 30 min grinding, 5 min pause, 30 cycles i.e. 15 h of effective grinding. After the first grinding, the powder tending to adhere to the walls must be detached with a spatula in a glovebox. This operation is repeated 3 times (i.e. 45 h of effective grinding) to obtain a homogeneous, amorphous compound.

The powder is heat treated in a sealed tube with carbon lining carried out as follows: 2 mL of acetone are charged in a quartz tube, and the tube is heated. Decomposition of the acetone will generate carbon which is deposited on the walls of the tube. In a glovebox, 1 g of the amorphous compound is pressed at 160 MPa, then placed in a carbon crucible. The whole is disposed in the tube which is placed under a vacuum before being sealed. Heat treatment of the sample is performed in an oven at a heating rate of 100° C./h up to 300° C., held for 4 h at this temperature, and then cooled to ambient temperature at a ramp of 100° C./h. After cooling, the tube is opened in a glovebox under argon.

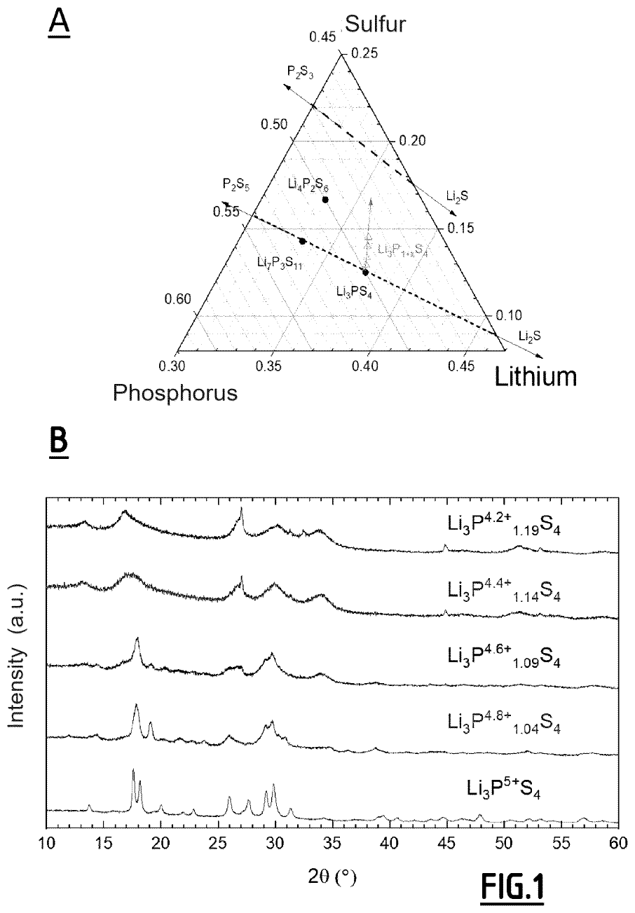

FIG. 1A illustrates the compositions of the examples in the ternary lithium-sulfur-phosphorus diagram. The examples of the invention lie in a right-hand segment which passes between the composition Li₃PS₄ and pure phosphorus.

The crystallographic structures of the examples were analyzed by X-ray diffraction on the powder of the samples using the copper K-alpha line. The analyses were performed under protection against air to prevent any parasitic reaction. (See FIG. 1B). The pattern intensity values to calculate the ratios I[34°]/Iₘₐₓ [29.5°;31°] and Iₘₐₓ [17°;18.5°]/Iₘₐₓ [18.5°;19.5°] correspond to the difference between the intensity of the overall signal of the pattern and the signal corresponding to the background noise of the pattern.

The intensities were calculated in relation to a baseline taking into account the slope of each diffraction pattern under consideration.

The ratios I[34°]/Iₘₐₓ [29.5°;31°] and Iₘₐₓ [17°;18.5°]/Iₘₐₓ [18.5°;19.5°] are grouped together in the Table below:

TABLE 2
ratio I[34°]/Iₘₐₓ [29.5°; 31°] and Iₘₐₓ [17°;
18.5°]/Iₘₐₓ [18.5°; 19.5°]

| | | Imax [17°; 18.5°]/Imax |
|---|---|---|
| | I[34°]/Imax [29.5°; 31°] | [18.5°; 19.5°] |
| Counter-example | <0.02 | 0.052631579 |
| Example 1 | 0.9 | 0.6 |
| Example 2 | 0.32 | 0.214285714 |
| Example 3 | 0.6 | 0.526315789 |

Conductivity measurements were performed by impedance spectroscopy by imposing an alternating current I between the 2 sides of an electrolyte pellet having a diameter of 7 mm and thickness e placed between 2 electrodes in stainless steel. Densification of the electrolyte was prepared either by uniaxial compression or by isostatic compression. The value of ionic conductivity σi is estimated from the relationship:

σ_{ionic}=e/(R*S)

where R is the resistance measured on the Nyquist diagram and the value thereof corresponds to the intersection of the signal relating to the blocking electrodes with the real axis.

Conductivity measurements were performed at 25° C., 45 and 60° C. thereby allowing estimation of activation energy.

Eₐ=−1/R*ln[σ(T₁)/(σ(T₂)]/(1/T₁−1/T₂),

with R=8.314 and T is the measuring temperature in Kelvin.

### Preparation of Electrochemical Cells:

The electrolyte layer acting as separator was prepared by compressing the powder in a die under a pressure of 300 MPa. A mixture of positive electrode, composed of powders of electrolyte and of cathode material LiNi_{0.80}Co_{0.15}Al_{0.15}O₂, was deposited on the layer of solid electrolyte and compressed under a pressure of 300 MPa. The mixture of negative electrode, composed of electrolyte powder and graphite, was placed on the other side of the solid electrolyte layer. The entire secondary battery was then compressed at 400 MPa. The sealed cell containing this battery allowed the maintaining of mechanical pressure at 100 MPa.

For symmetric cells, the two positive and negative electrodes were replaced by lithium films which were compressed onto the electrolyte layer under a pressure of 100 MPa.

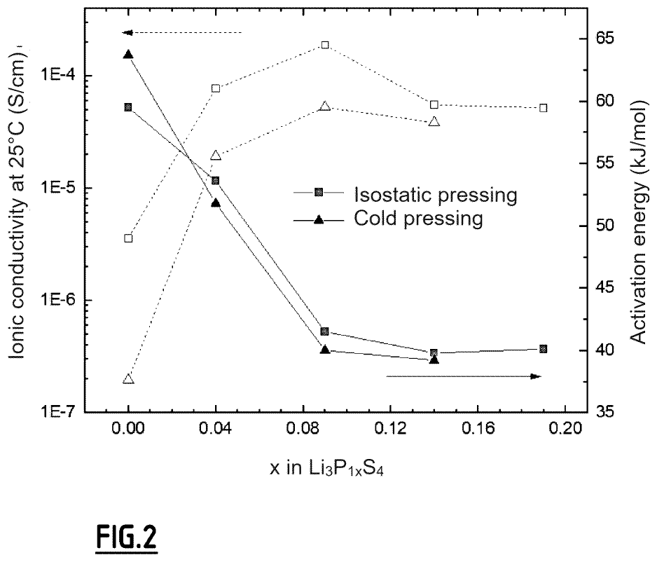

XRD analyses show the structural changes caused by the addition of phosphorus. These are characterized by changes in peak intensities compared with the Li₃PS₄ compound as shown in FIG. 2 and in Table 2.

The conductivity measurements in Examples 1 to 3 and in the counter-example are grouped together in FIG. 2. These show that when the phosphorus content is increased in the Li₃P₁₊ₓS₄ compounds, the conductivity of the electrolyte is improved and activation energy is reduced.

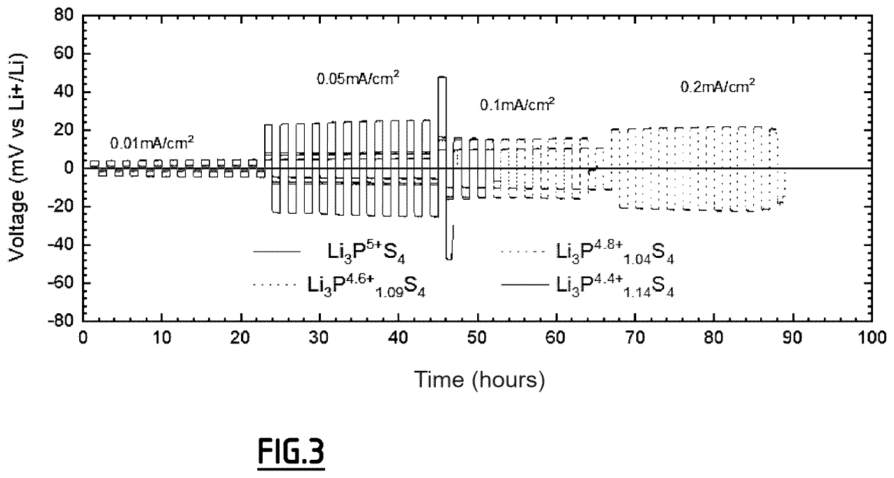

The lithium-based symmetric electrochemical cells were cycled at different current densities. FIG. 3 shows the change in polarization of the symmetric cells. At a current density of 0.05 mA/cm², the examples of the invention exhibit much lower polarizations than those of the material in the counter-example Li₃PS₄ (2 to 3 times lower).

The electrochemical cells assembled with graphite electrodes and LiNi_{0.80}Co_{0.15}Al_{0.15}O₂ cathode material were cycled at a rate of C/40.

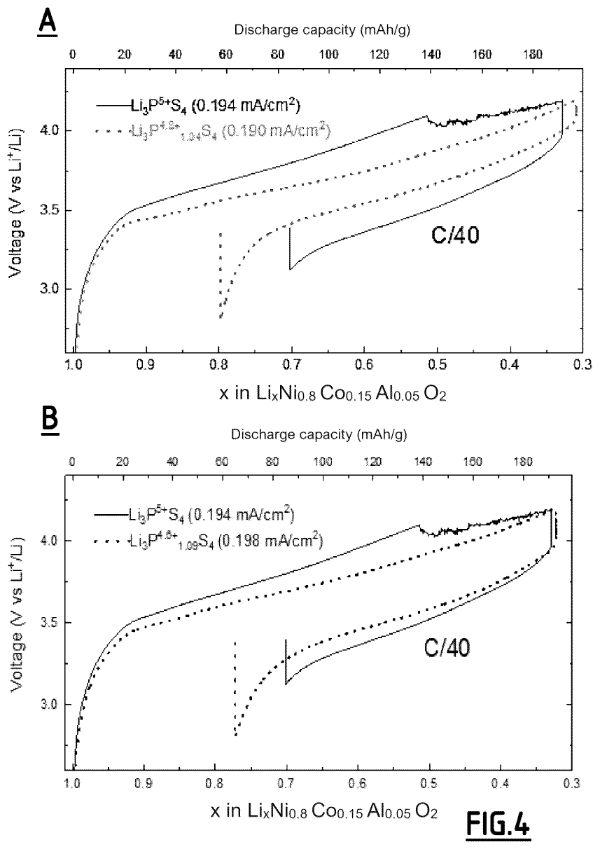

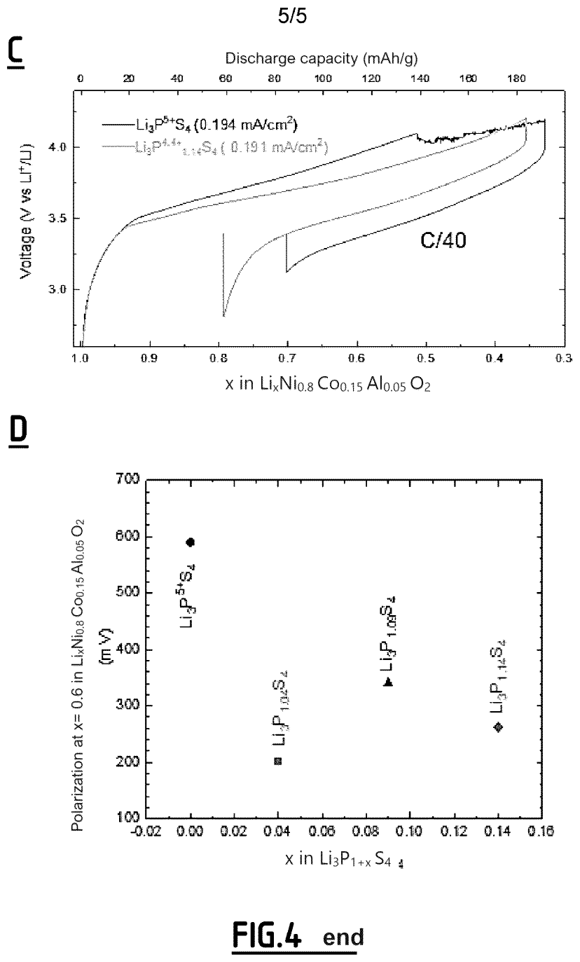

The charge and discharge curves (FIGS. 4A, B and C) show unstable voltage when charging the compound of the counter-example Li₃PS₄. This instability is characteristic of the formation of micro-short circuits. Contrary to compound Li₃PS₄, the materials of the invention exhibit a very regular charge curve. Additionally, it can be noted that the irreversible capacity (difference between charge and discharge capacity) is lower for the materials of the invention.

Similarly, polarization on charge and discharge, characterized for example by the voltage difference between charge and discharge for composition Li_{0.60}Ni_{0.80}Co_{0.15}Al_{0.15}O₂ (see FIG. 4D), is significantly lower for the materials of the invention.

Consequently, to summarize, the materials of the invention exhibit higher conductivity, lower cycling polarizations, lower irreversible capacities, and more regular charge curves than the Li₃PS₄ material.

1. Compound of formula (I):
$${( {Li}_{3} {P}_{1 + x} {S}_{4} )}_{1 - y} {( Li X )}_{y} \qquad ( I )$$
where:
0<x<0.2;
0≤y≤0.3;
Each X, the same or different for each group LiX, represents a halogen atom chosen from among Cl, I, Br, F.

2. The compound of formula (I) according to claim 1, such that y=0.

3. The compound of formula (I) according to claim 1, such that x lies between 0.04 and 0.14.

4. The compound of formula (I) according to claim 1, chosen from among Li₃P_{1.04}S₄, Li₃P_{1.09}S₄, and mixtures thereof.

5. The compound of formula (I) according to m such that it comprises the compound Li₃P_{1.09}S₄.

6. The compound of formula (I) according to claim 1, in crystalline or partially crystalline form.

7. The compound of formula (I) according to claim 1, having an X-ray (XRD) diffraction peak at 2θ=19.100+/−0.25° obtained with the copper K(alpha) line.

8. The compound of formula (I) according to claim 1, such that the ratio between the maximum intensity of the diffraction pattern in the range Iₘₐₓ [17°;18.5°] and the maximum intensity of the pattern in the range [18.5°;19.5°] is higher than 0.1 preferably between 0.1 and 1.00.

9. The compound of formula (I) according to claim 1, such that the ratio of the intensity of the X-ray (XRD) diffraction pattern at I=34.00° relative to the signal of maximum intensity in the range Iₘₐₓ [29.5°;31°] is higher than 0.04, preferably between 0.04 and 1.00.

10. A process for preparing a compound such as defined in claim 1 comprising:
the step of mixing the precursor powders P₂S₅ and Li₂S,
the addition of phosphorus at oxidation state zero, then
mechanical grinding or heating of the mixture obtained.

11. The process according to claim 10, such that the heating step is conducted at a temperature lower than 300° C.

12. A sulfide solid electrolyte comprising a compound of formula (I) according to claim 1.

13. The sulfide solid electrolyte according to claim 12 has a lithium ion conductivity value at ambient temperature higher than that of Li₃PS₄.

14. An all-solid-state electrochemical element comprising a cathode layer, an anode layer and an electrolyte layer between the anode and cathode layers, such that said electrolyte layer contains the sulfide solid electrolyte according to claim 12.

15. A module comprising a stack of at least two electrochemical elements according to claim 14.

16. A battery comprising one or more modules such as defined in claim 15.
